(19) United States
(12) Patent Application Publication
(10) Pub. No.: US 2024/0424606 A1
(43) Pub. Date: Dec. 26, 2024

(54) MACHINING OF CERAMIC MATRIX COMPOSITES WITH CURVED WATERJET GUIDED LASER

(71) Applicant: Raytheon Technologies Corporation, Farmington, CT (US)

(72) Inventors: Zhigang Wang, South Windsor, CT (US); Andrzej E. Kuczek, Bristol, CT (US); Robin H. Fernandez, East Haddam, CT (US); Alan C. Barron, Jupiter, FL (US); Ahmed Abdillahi Abdi, Oceanside, CA (US); Jason Nelson, Puyallup, WA (US); Andrew Joseph Lazur, La Jolla, CA (US)

(21) Appl. No.: 18/213,537

(22) Filed: Jun. 23, 2023

(51) Int. Cl. B23K 26/122; B23K 26/064; B23K 26/38

(52) U.S. Cl. CPC B23K 26/122; B23K 26/064; B23K 26/38; B23K 2103/52

(57) ABSTRACT

A method of machining a feature in a workpiece includes orienting a waterjet guided laser device about the workpiece, ejecting a waterjet from a nozzle of the waterjet guided laser device, impinging the waterjet against the workpiece along a tool path causing a corresponding removal of material therefrom, and generating a non-uniform electric field proximate the waterjet to cause a deflection of the waterjet as the waterjet is impinging against the workpiece.

### BACKGROUND

The present invention relates to ceramic matrix composites (CMCs), and more particularly, to means of machining CMCs.

CMCs are extremely hard and brittle and can therefore be hard to machine efficiently. Waterjet guided laser is considered as a promising manufacturing route for producing complex 3D holes. However, due to the non-contact nature of laser ablation, it can be difficult to generate a toolpath for complex 3D shapes with existing computer aided manufacturing (CAM) systems, which subsequently limits its application for 3D machining. Thus, it is necessary to develop a method to overcome the disadvantages.

### SUMMARY

A method of machining a feature in a workpiece includes orienting a waterjet guided laser device about the workpiece, ejecting a waterjet from a nozzle of the waterjet guided laser device, impinging the waterjet against the workpiece along a tool path causing a corresponding removal of material therefrom, and generating a non-uniform electric field proximate the waterjet to cause a deflection of the waterjet as the waterjet is impinging against the workpiece.

A system for machining a feature in a workpiece includes a holder for securing the workpiece and a waterjet guided laser device translatable relative to the workpiece. The waterjet guided laser device includes a nozzle for ejecting a waterjet, the waterjet having a laser beam, and at least one electrode disposed downstream of the nozzle. The system further includes a control module operatively connected to the waterjet guided laser device for selectively applying a voltage at a desired frequency to the at least one electrode to cause deflection of the waterjet corresponding to a tool path.

A method of machining a feature in a workpiece includes orienting a waterjet guided laser device about the workpiece, ejecting a waterjet from a nozzle of the waterjet guided laser device, impinging the waterjet against the workpiece along a tool path causing a corresponding removal of material therefrom, and generating a non-uniform electric field proximate the waterjet to cause a deflection of the waterjet as the waterjet is impinging against the workpiece. The deflection of the waterjet follows the tool path.

### BRIEF DESCRIPTION OF THE DRAWINGS

FIG. 1 is a simplified illustration of a waterjet guided laser device.

FIG. 2 is a simplified illustration of a waterjet guided laser device with at least one electrode.

FIG. 3 is a top-down view of drilling system 130 including the waterjet guided laser device of FIG. 2.

FIG. 4 is a simplified illustration of a waterjet guided laser device with multiple electrode pairs.

FIG. 5 is a simplified illustration of a metering hole and a spiral pattern used to drill a portion of the metering hole.

FIG. 6 is a simplified illustration of the waterjet guided laser device of FIG. 4 forming a curved cooling hole in a workpiece.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents means for controlling waterjet trajectory for machining 3D features (e.g., holes, pockets, slots, etc.) in CMCs, which makes it possible to use waterjet guided laser for machining complex 3D shaped features using a continuous toolpath. This improves the efficiency of the laser machining process, especially when the approach is used for machining 3D shaped holes. By accurately controlling waterjet trajectory, this technology could also be used to machine non-line-of-sight features.

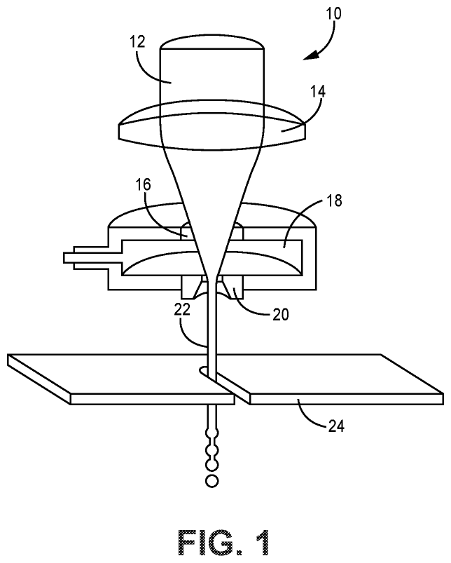

FIG. 1 is a simplified illustration of waterjet guided laser device 10. Device 10 includes laser beam 12 from a laser source, focusing lens 14, window 16, pressurized water chamber 18, and nozzle 20. In operation, laser beam 12 is focused by focusing lens 14 and window 16 as it reaches pressurized water chamber 18, filled with pressurized water. Cylindrical waterjet 22 with internally reflected laser beam 12 is ejected from nozzle 20 and impinges upon workpiece 24 causing removal of workpiece material along a predetermined tool path.

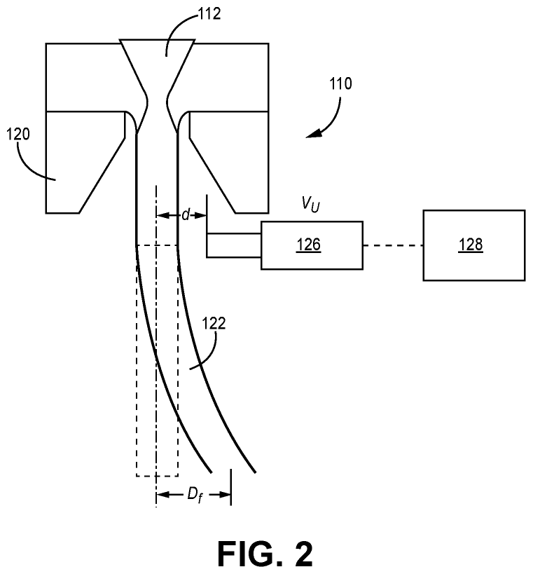

FIG. 2 is a simplified illustration of waterjet guided laser device 110 in the region of nozzle 120. Device 110 is substantially similar to device 10, except that device 110 includes at least one electrode 126 downstream of nozzle. Electrode 126 can be controlled to create a non-uniform electric field to deflect, or bend waterjet 122 by dielectrophoresis (DEP). DEP occurs when a polarizable particle is suspended in a non-uniform electric field. The electric field polarizes the particle and the poles then experience a force along the field lines, which can be either attractive or repulsive according to the orientation on the dipole. As shown in FIG. 2, d represents the distance between electrode 126 and the centerline of waterjet 122 and D_{f} is the deflection of waterjet 122. Deflection can generally be estimated by the equation D_{f}=CVu²/dP, where V_{U} is the applied voltage, P is the pressure of waterjet 122, and C is a constant depending on the electric field. Accordingly, it is possible to deflect waterjet 122 without moving the source of laser beam 112 by keeping d and P fixed, and selectively changing the applied voltage V_{U}, as is discussed in greater detail below. In one example, voltage control can be carried out using an amplifier with an output voltage ranging from 0 V to 1400 V, a slew rate of 370 V/μs, and a large signal bandwidth greater than 125 kHz. Such an amplifier could be included as part of control module 128, which can be operably connected to device 110 to control the operation of waterjet 122 and electrode(s) 126.

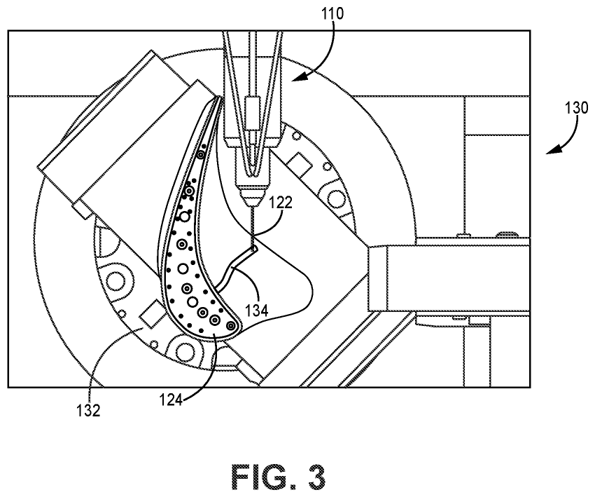

FIG. 3 is a top-down view of drilling system 130 which includes device 110 and holder 132 for securing workpiece 124. In the embodiment shown, workpiece 124 is an airfoil. Waterjet 122 of device 110 can be selectively deflected, as discussed above, to drill non-line of sight metering holes 134 in workpiece 124 without the need to frequently reposition device 110 or workpiece 124 relative to one another, which can lead to misalignment between a non-deflected waterjet 122 and the axes of metering holes 134. In some cases, workpiece 124 can remain static while metering holes are drilled by deflection of waterjet 122 with minimal movement of device 110 required. This can be preferable as the mass of system 130 presents inertial challenges with respect to the tool paths necessary to drill complex features (e.g., holes 132). Accordingly, the relatively low inertia of waterjet 122 allows it to be more responsive to directional changes.

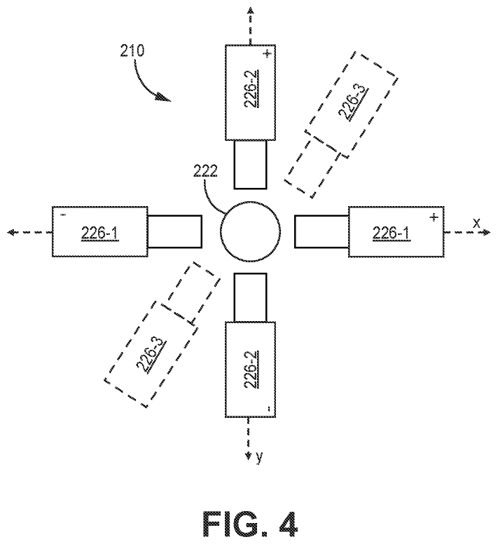

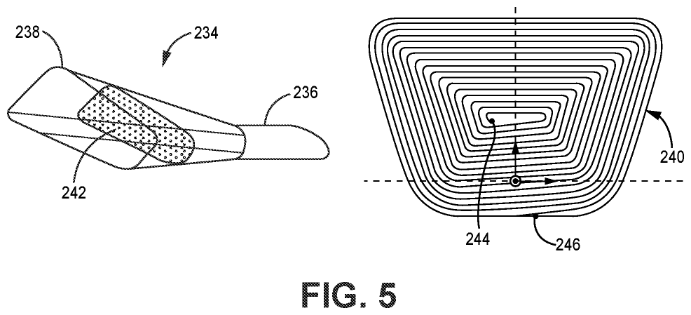

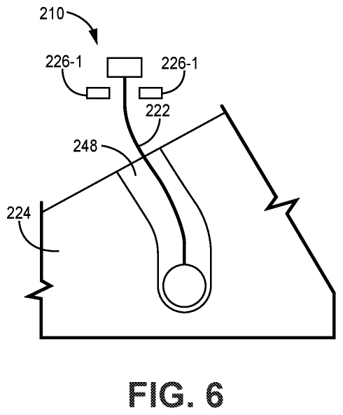

FIG. 4 is a simplified illustration of waterjet guided laser device 210 with multiple electrodes for deflecting waterjet 222. Device 210 is otherwise substantially similar to devices 10 and 110. Device 210 includes first electrode pair 226-1 oriented along the x-axis, and second electrode pair 226-2 oriented along the y-axis. Each electrode pair 226-1 is oppositely disposed relative to water jet 222, and each electrode pair 226-2 is also oppositely disposed relative to waterjet 222. Each electrode pair 226-1 and 226-2 can have a positive (+) electrode and a negative (−) electrode. It should be noted that device 210 can include additional electrode pairs (e.g., 226-3, represented by dashed lines, to 226-n) variably offset from the x and y-axes. Device 110 can be similarly configured. Device 210 may be preferable for creating intricate spiral patterns or curved holes in a workpiece, as is discussed below with respect to FIGS. 5 and 6.

FIG. 5 is a simplified illustration of metering hole 234 having metering section 236 and diffuser section 238. FIG. 5 also illustrates spiral pattern 240, which corresponds to cross-sectional plane 242 of diffuser section 238. Spiral pattern 240 can be formed by the inside-out movement of waterjet 222 from point 244 to point 246. However, rather than translating device 210 along a corresponding spiral tool path, electrode pairs 226-1 and 226-2 can be selectively operated to deflect the waterjet in a spiral tool path in the x-y plane without the need to translate the underlying workpiece, and with little to no movement of device 210 required. Other sectional planes corresponding to metering section 236 and diffuser section 238 can be similarly drilled to form metering hole 234. FIG. 6 is a simplified illustration of a portion of waterjet guided laser device 210 forming curved cooling hole 248 in workpiece 224, which can be an airfoil or other component for a gas turbine engine. Only first electrode pair 226-1 is visible in FIG. 6.

To form holes 234 or 248, a control module (e.g., control module 128) can operate to variably apply voltage to electrode pairs 226-1 and 226-2 according to a pre-programmed tool path. The combination of the positively charged and negatively charged electrodes of a given pair (e.g., 226-1) can deflect waterjet 222 in the same direction, as one acts to repel and the other to attract waterjet 222. It can also be possible to configure device 210 such that the polarity of a given pair of electrodes can be reversed, as necessary, to achieve maximum deflection and/or changes in direction. As such, an applied DC voltage, or DC-biased AC voltage can be preferable. In addition to controlling the electric field via the voltage applied to individual electrodes and/or polarity across a given pair, the frequency ω and amplitude V₀ of the applied voltage can also be controlled (e.g., varied) to influence the direction and/or degree of deflection. For example, if the applied voltage

$${V}_{U} = {V}_{0} sin ( \frac{ω t}{2} ) ,$$

then deflection

$${D}_{f} = C \frac{{V}_{u}^{2}}{dP} = C \frac{{V}_{0}^{2}}{dP} {sin}^{2} \frac{ω t}{2} = C \frac{{V}_{0}^{2}}{dP} \frac{1 - cos ω t}{2} .$$

Such means of controlling the electric field therefore allow deflection of waterjet 222 to follow the tool path necessary to machine complex features.

The disclosed waterjet guided laser devices can be used to form non-line of sight and/or complexly shaped holes in CMC components for use in aerospace, maritime, or industrial equipment, to name a few, non-limiting examples.

### Discussion of Possible Embodiments

The following are non-exclusive descriptions of possible embodiments of the present invention.

A method of machining a feature in a workpiece includes orienting a waterjet guided laser device about the workpiece, ejecting a waterjet from a nozzle of the waterjet guided laser device, impinging the waterjet against the workpiece along a tool path causing a corresponding removal of material therefrom, and generating a non-uniform electric field proximate the waterjet to cause a deflection of the waterjet as the waterjet is impinging against the workpiece.

The method of the preceding paragraph can optionally include, additionally and/or alternatively, any one or more of the following features, configurations and/or additional steps:

In the above method, generating the non-uniform electric field can include selectively applying a voltage to at least one electrode, the at least one electrode positioned downstream of the nozzle.

In any of the above methods, the voltage can range from 0 to 1400.

In any of the above methods, the at least one electrode can include a first electrode pair disposed along a first axis and a second electrode pair disposed along an orthogonal second axis.

In any of the above methods, generating the non-uniform electric field can include selectively applying a voltage to the first electrode pair and the second electrode pair.

In any of the above methods, generating the non-uniform electric field can further include varying at least one of a frequency and an amplitude of the voltage.

In any of the above methods, generating the non-uniform electric field can include reversing a polarity of the first electrode pair of the second electrode pair.

In any of the above methods, the tool path can form a curved cooling hole.

In any of the above methods, the tool path can form a spiral pattern.

Any of the above methods can further include mounting the workpiece in a holder and keeping the workpiece stationary while impinging the waterjet against the workpiece.

A system for machining a feature in a workpiece includes a holder for securing the workpiece and a waterjet guided laser device translatable relative to the workpiece. The waterjet guided laser device includes a nozzle for ejecting a waterjet, the waterjet having a laser beam, and at least one electrode disposed downstream of the nozzle. The system further includes a control module operatively connected to the waterjet guided laser device for selectively applying a voltage at a desired frequency to the at least one electrode to cause deflection of the waterjet corresponding to a tool path.

The system of the preceding paragraph can optionally include, additionally and/or alternatively, any one or more of the following features, configurations and/or additional components:

In the above system, the at least one electrode can include a first electrode pair disposed along a first axis.

In any of the above systems, the at least one electrode can further include a second electrode pair disposed along an orthogonal second axis.

In any of the above systems, the voltage can range from 0 to 1400.

In any of the above systems, the voltage can be one of a DC voltage and a DC-biased AC voltage.

A method of machining a feature in a workpiece includes orienting a waterjet guided laser device about the workpiece, ejecting a waterjet from a nozzle of the waterjet guided laser device, impinging the waterjet against the workpiece along a tool path causing a corresponding removal of material therefrom, and generating a non-uniform electric field proximate the waterjet to cause a deflection of the waterjet as the waterjet is impinging against the workpiece. The deflection of the waterjet follows the tool path.

The method of the preceding paragraph can optionally include, additionally and/or alternatively, any one or more of the following features, configurations and/or additional steps:

In the above method, generating the non-uniform electric field can include applying a voltage to the at least one electrode, and controlling at least one of an amplitude or a frequency of the voltage.

In any of the above methods, the voltage can range from 0 to 1400.

In any of the above methods, the at least one electrode can include a first electrode pair disposed along a first axis and a second electrode pair disposed along an orthogonal second axis.

In any of the above methods, generating the non-uniform electric field can include reversing a polarity of the first electrode pair of the second electrode pair.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of machining a feature in a workpiece, the method comprising:
orienting a waterjet guided laser device about the workpiece;
ejecting a waterjet from a nozzle of the waterjet guided laser device;
impinging the waterjet against the workpiece along a tool path causing a corresponding removal of material therefrom; and
generating a non-uniform electric field proximate the waterjet to cause a deflection of the waterjet as the waterjet is impinging against the workpiece.

2. The method of claim 1, wherein generating the non-uniform electric field comprises selectively applying a voltage to at least one electrode, the at least one electrode positioned downstream of the nozzle.

3. The method of claim 2, wherein the voltage ranges from 0 to 1400.

4. The method of claim 2, wherein the at least one electrode comprises a first electrode pair disposed along a first axis and a second electrode pair disposed along an orthogonal second axis.

5. The method of claim 4, wherein generating the non-uniform electric field comprises selectively applying a voltage to the first electrode pair and the second electrode pair.

6. The method of claim 5, wherein generating the non-uniform electric field further comprises varying at least one of a frequency and an amplitude of the voltage.

7. The method of claim 4, wherein generating the non-uniform electric field comprises reversing a polarity of the first electrode pair of the second electrode pair.

8. The method of claim 1, wherein the tool path forms a curved cooling hole.

9. The method of claim 1, wherein the tool path forms a spiral pattern.

10. The method of claim 1 and further comprising: mounting the workpiece in a holder and keeping the workpiece stationary while impinging the waterjet against the workpiece.

11. A system for machining a feature in a workpiece, the system comprising:
a holder for securing the workpiece;
a waterjet guided laser device translatable relative to the workpiece, the waterjet guided laser device comprising:
a nozzle for ejecting a waterjet, the waterjet comprising a laser beam; and
at least one electrode disposed downstream of the nozzle; and
a control module operatively connected to the waterjet guided laser device for selectively applying a voltage at a desired frequency to the at least one electrode to cause deflection of the waterjet corresponding to a tool path.

12. The system of claim 11, wherein the at least one electrode comprises a first electrode pair disposed along a first axis.

13. The system of claim 12, wherein the at least one electrode further comprises a second electrode pair disposed along an orthogonal second axis.

14. The system of claim 11, wherein the voltage ranges from 0 to 1400.

15. The system of claim 11, wherein the voltage is one of a DC voltage and a DC-biased AC voltage.

16. A method of machining a feature in a workpiece, the method comprising:
orienting a waterjet guided laser device about the workpiece;
ejecting a waterjet from a nozzle of the waterjet guided laser device;
impinging the waterjet against the workpiece along a tool path causing a corresponding removal of material therefrom; and
generating a non-uniform electric field proximate the waterjet to cause a deflection of the waterjet as the waterjet is impinging against the workpiece;
wherein the deflection of the waterjet follows the tool path.

17. The method of claim 17, wherein generating the non-uniform electric field comprises:
applying a voltage to the at least one electrode; and
controlling at least one of an amplitude or a frequency of the voltage.

18. The method of claim 17, wherein the voltage ranges from 0 to 1400.

19. The method of claim 17, wherein the at least one electrode comprises a first electrode pair disposed along a first axis and a second electrode pair disposed along an orthogonal second axis.

20. The method of claim 19, wherein generating the non-uniform electric field comprises reversing a polarity of the first electrode pair of the second electrode pair.
